(19) United States
(12) Patent Application Publication
(10) Pub. No.: US 2023/0191383 A1
(43) Pub. Date: Jun. 22, 2023

(54) FORMULATIONS FOR METAL CATALYSIS IN WATER COMPRISING A SURFACTANT AND A LIPOPHILIC COMPOUND

(71) Applicants: UNIVERSITE DE STRASBOURG, Strasbourg (FR); AVIGNON UNIVERSITE, Avignon (FR); Centre National de la Recherche Scientifique, Paris (FR); UNIVERSITE DE MONTPELLIER, Montpellier (FR); ECOLE NATIONALE SUPERIEURE DE CHIMIE DE MONTPELLIER, Montpellier (FR)

(72) Inventors: Frédéric Bihel, Fegersheim (FR); Damien Bourgeois, Aramon (FR); Christiane Contino-Pepin, Althen Des Paluds (FR); Stéphane Desgranges, Avignon (FR); Valentin Lacanau, Avignon (FR)

(21) Appl. No.: 17/999,346

(22) PCT Filed: May 27, 2021
(86) PCT No.: PCT/EP2021/064256

§ 371 Date: Nov. 18, 2022

(30) Foreign Application Priority Data
May 27, 2020 (FR) FR2005610

(51) Int. Cl. B01J 31/06; B01J 31/02; B01J 35/00; B01J 31/22

(52) U.S. Cl. CPC B01J 31/064; B01J 31/22; B01J 31/0209; B01J 35/0013; B01J 2531/16; B01J 2531/842

(57) ABSTRACT

A dry formulation obtained by desiccation of an emulsion comprises at least one surfactant, at least one lipophilic compound, and at least one metal catalyst. The dry formulation may be used to carry out a catalysed reaction in an aqueous medium. The dry formulation has a water content of less than (10) wt% relative to the total weight of the dry formulation, and wherein: - the at least one surfactant is selected from the group comprising dendrimers of Dendri-TAC type, oligomers of F,TACn or H,TACn type, TPGS 1000, TPGS 750 M, surfactants derived from sugars and/or amino acids, and combinations thereof; - the at least one lipophilic compound is selected from the group comprising lipids, hydrophobic complexing agents and combinations thereof; and - the metal catalyst comprises a metal selected from Groups (3) to (12) of the Periodic Table.

### TECHNICAL FIELD OF THE INVENTION

The present description relates to a dry formulation comprising at least one surfactant, at least one lipophilic compound and at least one metal catalyst, as well as to the use of such a dry formulation for carrying out a catalyzed reaction in an aqueous medium. The present description also relates to the use of a dry formulation comprising at least one surfactant and at least one lipophilic compound, wherein a metal catalyst is brought together with the dry formulation or with an emulsion formed by bringing together water with the dry formulation, for carrying out a catalyzed reaction in an aqueous medium.

### PRIOR ART

The development of environmentally friendly alternatives to organic solvents of fossil origin corresponds to a priority strategy of the chemical industry. In particular, the use of water as solvent is a very attractive approach. Some metal-catalyzed reactions were, for example, able to be successfully developed in water using a surfactant, by “micellar” catalysis.

The proof of concept was established by Bruce Lipshutz et al. for palladium cross-coupling reactions, such as Suzuki-Miyaura, Heck and Sonogashira reactions, using the surfactant TPGS-750-M (2 wt% in water).

The document WO 2017/198846 A1 describes the use of H/F-TAC surfactants and H/F-DendriTACs for the liquid-liquid extraction of a Group 10 metal or gold, in particular palladium, from organic compositions further comprising an extractant. One of the objectives of the document is to directly upgrade the extracted aqueous solution containing the metal and the surfactant in a reaction catalyzed by the metal, e.g. a Pd(II)-catalyzed cross-coupling reaction, under micellar conditions.

The paper [L. Leclercq et al., Supramolecular Chemistry and Self-Organization: A Veritable Playground for Catalysis″, Catalysts, 2019, 9(2), 163] is a review describing different catalytic systems for metal-catalyzed reactions in water, including micelles (with a size approximately of between 1 and 10 nm) and microemulsions (with a size approximately of between 10 and 100 nm) stabilized by surfactants. The paper emphasizes the disadvantages inherent in the presence of a surfactant in such systems, such as the difficulty of separating the surfactant from the reaction product, and presents alternatives to the use of surfactants involving the self-assembly of supramolecular architectures.

However, one of the recurring disadvantages of micelle-based chemistry is the low solubility of the reagents. In order to circumvent this problem, alternatives consist in increasing the amount of surfactant and/or in adding a significant amount (up to 20% v/v) of an organic cosolvent, as described in the paper by C.M. Gabriel et al., “Effects of Co-solvents on Reactions Run under Micellar Catalysis Conditions”, Organic Letters (2017), 19, pp. 194-197. Although this last approach can in some cases lead to an increase in the yield of the reaction, the addition of such an amount of organic solvent appears inappropriate in view of the primary objective of micellar reactors, which is to replace organic solvents of fossil origin as reaction media. Finally, the state of the art based on micellar catalysis very largely involves the surfactant TPGS-750-M, available in the form of a solution in water, and remains silent on the development of a catalyst and/or of a reactor which can be stored in solid form for metal catalysis in water.

### SUMMARY OF THE INVENTION

In the present description and in the claims, the term “to comprise” means the same thing as “to include” or “to contain”, and is inclusive or open and does not exclude other elements not described or represented. Furthermore, in the present description, the terms “approximately” and “substantially” are synonymous with (mean the same thing as) a lower and/or upper margin of 10%, for example 5%, of the respective value.

One of the objectives of the present description is to provide a reaction medium for metal catalysis in water which is easily storable and transportable and which is ready for use by simple addition of water.

According to a first aspect of the present description, such an objective is achieved by a dry formulation obtained by drying an emulsion, the dry formulation comprising at least one surfactant, at least one lipophilic compound, and at least one metal compound. According to one or more embodiments, the metal compound is a metal catalyst. The inventors have found, surprisingly, that such a dry formulation could serve as improved catalytic reactor for carrying out metal-catalyzed reactions, that is to say reactions catalyzed by metals, in an aqueous medium. The advantage in catalysis of such a dry formulation according to the present description is reflected by superior or comparable performance qualities in comparison with conventional micellar catalysis, for example in terms of yields of the metal-catalyzed reaction, in terms of ease of implementation of the catalysis reaction (e.g. ease of weighing, of insertion of the formulation into the medium, of dissolution in water), in terms of stability and ease on storage of the formulation (easy storage of solid systems, e.g. powdery systems, in comparison for example with reagents sold in solution in water).

Such a dry formulation can potentially be used in the fields of cosmetics, food processing, pharmaceuticals, nutraceuticals and/or probiotics. Thus, according to another aspect, the present description relates to the use of the dry formulation according to the first aspect in the fields of cosmetics, food processing, pharmaceuticals, nutraceuticals and/or probiotics.

In the following, the dry formulation is as defined above with reference to the first aspect or according to any one of the embodiments described subsequently, which apply to the dry formulation as is as well as to its use in catalysis described in the second aspect of the present description.

The dry formulation is obtained by drying an emulsion. According to one or more embodiments, the drying of the emulsion comprises the lyophilization of the emulsion, the atomization of the emulsion (spray drying), the electrospinning of the emulsion or combinations thereof. According to one or more embodiments, the drying of the emulsion comprises the lyophilization of the emulsion.

According to one or more embodiments, the dry formulation additionally comprises at least one cryoprotectant selected from the group comprising polymers, amino acids, saccharide compounds, such as mono-, di- and polysaccharides, and combinations thereof. According to one or more embodiments, the at least one cryoprotectant is selected from the group comprising trehalose, sucrose, maltose, glucose, mannitol, hydroxypropyl-β-cyclodextrin, and combinations thereof. In other embodiments, the at least one cryoprotectant is a polymer, such as a polyvinylpyrrolidone or a polyvinyl alcohol. The at least one cryoprotectant can also be an amino acid, such as glycine.

According to one or more embodiments, the dry formulation is substantially devoid of water. According to one or more embodiments, the water content of the dry formulation is less than 10 wt%, with respect to the total weight of the dry formulation, for example less than 5 wt%, 4 wt%, 3 wt%, 2 wt%, 1 wt%.

In the present description and in the claims, unless otherwise indicated, the term metal catalyst is understood to mean a compound comprising molecules and/or nanoparticles including one or more metal atoms, and which can be directly or indirectly involved in the catalysis of one or more chemical reactions. The term directly is understood to mean that the metal catalyst is an active entity of the catalytic cycle of the chemical reaction(s) in question. The term indirectly is understood to mean that the metal catalyst is a dormant entity and/or a precursor of an active entity of the catalytic cycle of the chemical reaction(s) in question, it being possible for the precursor to be direct or upstream of a limited number of steps, i.e. of chemical reactions, for example ranging from 2 to 5 steps, leading from the precursor to the active entity. Whatever the involvement of the metal catalyst in the catalysis of the chemical reaction(s), i.e. direct or indirect, in the present description and in the claims, unless otherwise indicated, use will be made of the term metal catalyst for said chemical reaction(s), the latter being said to be “metal-catalyzed” or “catalyzed by the metal catalyst”. According to one or more embodiments, the dry formulation comprises several metal catalysts for the same chemical reaction, for example two metal catalysts for the same chemical reaction, in the sense that the two metal catalysts are both involved directly and/or indirectly (e.g., one directly, the other indirectly, both directly or both indirectly) in the catalysis of the same chemical reaction. For example, the dry formulation can comprise two different active entities of the catalytic cycle of one and the same chemical reaction.

According to one or more embodiments, the metal catalyst is homogeneous, for example defined by an organometallic chemical structure, comprising a metal atom to which one or more organic ligands is/are coordinated. According to one or more embodiments, the metal catalyst is, for example, defined by one or more metal particles comprising the arrangement of several metal atoms, for example one or more metal nanoparticles. According to one or more embodiments, the metal catalyst comprises a transition metal, namely a metal selected from Groups 3 to 12 of the Periodic Table. For example, the metal catalyst can comprise a transition metal selected from Groups 8 to 11, i.e. a late transition metal, such as, for example, iron, ruthenium, osmium, cobalt, rhodium, iridium, nickel, palladium, platinum, copper, silver or gold.

According to one or more embodiments, the dry formulation is obtained by a process comprising the following steps:
providing a mixture comprising water, the at least one surfactant, the at least one lipophilic compound and a source comprising the at least one metal catalyst;
emulsifying the mixture, resulting in the formation of the emulsion;
wherein the emulsion comprises:
a continuous aqueous phase; and
a discontinuous phase comprising the at least one lipophilic compound, the at least one surfactant and the at least one metal catalyst extracted from the source during the emulsification; and
drying, for example lyophilization or other drying by sublimation, of the emulsion, resulting in the dry formulation being obtained.

According to one or more embodiments, the source comprising the at least one metal catalyst is selected from the group comprising a metal-accumulating plant, a metal-accumulating fungus or a metal-accumulating alga, material resulting from the recycling of electronic waste, polluted surface or ground water comprising predetermined concentrations of metals, an ore and combinations thereof. According to one or more embodiments, the water and/or at least one of the at least one lipophilic compound included in the mixture originates exclusively from the source. According to one or more embodiments, the material resulting from the recycling of electronic waste comprises a micellar solution resulting from the back extraction of an organic phase which has been used to extract the at least one metal catalyst and which comprises, besides the at least metal catalyst, for example at least one organic solvent and/or at least one hydrophobic complexing agent.

In addition, according to one or more embodiments, the at least one lipophilic compound may be entirely contained in the source. This is because it is possible to select certain plant or fungal matrices which can release lipophilic compounds, for example under the effect of an energy supply.

Emulsifying the mixture results in the formation of an emulsion comprising a continuous aqueous phase and a discontinuous phase comprising the at least one lipophilic compound, the at least one surfactant and the at least metal catalyst extracted from the source. The discontinuous phase can, for example, comprise droplets comprising the at least one lipophilic compound, the at least one surfactant and the at least one metal catalyst.

According to one or more embodiments, the discontinuous lipid phase is provided in the form of droplets with a predetermined mean diameter D.

According to one or more embodiments, the predetermined mean diameter D of said droplets is between approximately 100 nm and approximately 6000 nm, for example between 100 and 3000 nm.

According to one or more embodiments, emulsifying the mixture comprises the application of a source of energy to the mixture, which can be ultrasonic energy, purely mechanical energy and/or energy in the form of a heat supply, or combinations thereof.

According to one or more embodiments, emulsifying the mixture comprises sonicating the mixture. Sonicating the mixture can comprise applying an ultrasound energy source to the mixture.

According to one or more embodiments, the process for obtaining the dry formulation comprises a step of ultracentrifugation of the emulsion. Such an ultracentrifugation step can, for example, comprise one or more ultracentrifugation steps at predetermined speeds, for example of between 1000 G and 50 000 G. According to one or more embodiments, such a step makes it possible to lower at least one among the mean diameter D of the droplets and the polydispersity index of the emulsion, and for example both this diameter and the polydispersity.

According to one or more embodiments, the process for obtaining the dry formulation also comprises the addition of at least one cryoprotectant to the mixture. This addition can take place before the emulsifying and/or during the emulsifying and/or once the mixture has been emulsified. The addition of a cryoprotectant can in particular make it possible to confer additional protection on the emulsions obtained after the emulsifying, for example during the step of drying the emulsion, for example during a lyophilization step. According to one or more embodiments, the at least one cryoprotectant is selected from the group comprising polymers, amino acids, saccharide compounds, such as mono-, di- and polysaccharides, and combinations thereof. According to one or more embodiments, the at least one cryoprotectant is selected from the group comprising trehalose, sucrose, maltose, glucose, mannitol, hydroxypropyl-β-cyclodextrin and combinations thereof. In other implementational examples, the at least one cryoprotectant is a polymer, such as a polyvinylpyrrolidone or a polyvinyl alcohol. The at least one cryoprotectant can also be an amino acid, such as glycine.

The drying step can, for example, be adapted to the nature of the metal catalyst and to its inherent sensitivity. The duration of the drying step can vary from a few hours to several days.

According to one or more embodiments, when the drying step comprises a lyophilization stage, the lyophilization step can comprise at least three substeps: freezing; sublimation, in order to sublimate the water from said mixture; and drying, in order to reduce the residual moisture content. According to one or more embodiments, in the freezing, the mixture after the emulsifying is brought to a temperature lower than a predetermined temperature, for example lower than 0° C., lower than -10° C. or less, such as to approximately -20° C., or approximately -40° C. According to one or more embodiments, the sublimation can take place at a pressure lower than a predetermined pressure, for example between 50 and 1000 µbars, for example of approximately 500 µbars. According to one or more embodiments, in the drying, said resulting mixture is brought to a temperature greater than a predetermined temperature, for example greater than approximately 10° C., for example greater than approximately 20° C.

Thus, dry formulations enriched in storable and easily transportable metal catalysts can be obtained by said process, in a minimum of steps. Starting from such dry formulations, the corresponding emulsions are easy to reconstitute, by simple rehydration, i.e. by addition of a certain amount of water or aqueous solution to the dry formulation in order to reform an emulsion. The emulsion thus reconstituted by rehydration will not necessarily have the same features as the starting emulsion, i.e. the emulsion before drying. For example, when the discontinuous phase comprises droplets comprising the at least one lipophilic compound, the at least one surfactant and the at least one metal catalyst, the mean diameter D of the droplets and/or the polydispersity index PI of the reconstituted emulsion can differ in their values in the emulsion before drying and after drying/rehydration (i.e. drying followed by rehydration).

According to one or more embodiments, the at least one lipophilic compound is selected from the group comprising lipids, hydrophobic complexing agents and combinations thereof. The presence of such lipophilic compounds makes it possible to confer selected properties on the formulation obtained by drying an emulsion according to the first aspect.

Such a lipophilic compound confers an improved stability on the dry formulation in the form of a storable and easily transportable powder. The nature of such a lipophilic compound confers on it good resistance to drying. For example, such lipophilic compounds confer an improved stability on the discontinuous phase of the emulsion from which the dry formulation can be obtained, when the latter is obtained by the process comprising the drying of the emulsion, described above with reference to one or more embodiments of the present description.

The presence of such a lipophilic compound in the dry formulation also contributes to improving the performance of the dry formulation for metal catalysis as a “reactor set” ready for use by simple addition of water, in comparison with micellar catalysis involving only a surfactant or micellar catalysis involving the addition of usual organic co-solvents.

According to one or more embodiments, the lipid is selected from the group comprising glycerol mono-, di- or triesters, or glycerol derivatives, citric acid mono-, di-, tri- or tetraesters or citric acid derivatives, fatty acids, monoesters of fatty acids, sterides, sphingolipids, glycerophospholipids, polyketides, saccharolipids, lipids derived from prenol, essential oils, fat substitutes, waxes and combinations thereof. According to one or more embodiments, the lipid is selected from the group comprising lipids which are not of fossil origin. The dry formulation then forms a set of “green” reactors, i.e. devoid of usual organic solvents of fossil origin.

According to one or more embodiments, the hydrophobic complexing agent comprises at least one metal-chelating group, e.g. a Lewis base, and at least one linear alkyl chain, for example a chain of 3 to 50 carbon atoms. According to one or more embodiments, the hydrophobic complexing agent is selected from the group comprising trialkyl phosphates and dialkyl sulfides.

According to one or more embodiments, the at least one lipophilic compound is present in a percentage by weight, with respect to the total weight of the dry formulation, of at least 10 wt%, for example of at least 20 wt%, of at least 30 wt%, of at least 40 wt%, of at least 50 wt%. For example, the at least one lipophilic compound is present in a percentage by weight, with respect to the total weight of the dry formulation, of between 40 wt% and 95 wt%, between 40 wt% and 75 wt%. According to one or more embodiments, the formulation comprises at least 50 wt% of lipophilic compound(s), between 10 wt% and 40 wt% of surfactant(s) and between 0.000001 wt% and 25 wt% of metal catalyst(s).

According to one or more embodiments, the at least one surfactant is selected from the group comprising dendrimers of Dendri-TAC type, oligomers of FᵢTACₙ or HᵢTACₙ type, TPGS 1000, TPGS 750 M, surfactants derived from sugars and/or amino acids, and combinations thereof.

According to one or more embodiments, the at least one surfactant is an oligomer of FᵢTACₙ or HᵢTACₙ type. Such compounds comprise a hydrophilic part (or “polar head”) comprising an oligomer of polyTRIS type (for “poly Tris(hydroxymethyl)aminomethane”) and a hydrophobic part comprising a linear alkyl chain, which is fluorinated for the oligomers of FᵢTACₙ type. The number n is the degree of oligomerization of the polyTRIS part and i is the number of carbon atoms of the linear alkyl chain.

According to one or more embodiments, i is between 6 and 16, for example between 8 and 12, and n is between 5 and 20, for example between 5 and 10.

According to one or more embodiments, the amphiphilic compound comprises a dendrimer of Dendri-TAC type, such as those described in the patent application EP 3 095 806 A1. Dendri-TACs are a class of biocompatible amphiphilic compounds having self-assembling and highly modulable properties, whether at the hydrophobic tail or the multiplication of the branches of the hydrophilic head. Surfactants of Dentri-TAC type, due to their dendritic, i.e. arborescent, molecular architecture, make possible the appearance of internal cavities which can constitute as many compartments, the presence of which can influence the course of the catalysis in an aqueous medium, when the dry formulation is intended to be used in such a context. According to a second aspect, the present description relates to the use of a dry formulation according to any one of the embodiments of the first aspect to carry out a catalyzed reaction in an aqueous medium. In that which follows, the dry formulation is as defined above with reference to the first aspect or according to any one of the embodiments described subsequently, which apply to the dry formulation as is as well as to its use in catalysis described below.

The inventors were able to observe, with surprise, that the dry formulation described in the first aspect lent itself well to use for carrying out the catalysis of metal-catalyzed reactions in an aqueous medium, e.g. in a medium containing at least 70% (by volume) of water or in water. Whether in terms of performance, for example in terms of yields obtained in comparison with conventional micellar conditions, or of the practicality of using storable and easily transportable reactors ready for use by simple addition of water, the dry formulations give very satisfactory results for use in catalysis.

The use according to one or more embodiments of the second aspect of the present description comprises bringing together at least one reagent of the metal-catalyzed chemical reaction with the dry formulation according to the first aspect. According to one or more embodiments, the bringing together of the at least one reagent with the dry formulation takes place once the dry formulation has been hydrated, i.e. once water or an aqueous solution containing at least 70% (by volume) of water has been added to the dry formulation. According to one or more embodiments, the aqueous solution can comprise, besides the water, water-soluble organic solvents. According to one or more embodiments, the use can comprise the addition of at least one organic solvent to the dry formulation (or to the hydrated dry formulation) (e.g., acetone, acetonitrile, THF, Me-THF, toluene, dichloromethane, dioxane, DMF, and the like) in an amount of greater than 1% (by volume), with respect to the amount of water added to the dry formulation.

According to one or more embodiments, the use comprises bringing together water or an aqueous solution with the dry formulation, resulting in the formation of an emulsion comprising:
a discontinuous phase comprising droplets including the at least one surfactant, the at least one lipophilic compound and the at least one metal catalyst;
a continuous aqueous phase.

According to one or more embodiments, the use comprises a step of treatment of the emulsion formed by bringing together water or an aqueous solution with the dry formulation. According to one or more embodiments, the treatment step can take place before at least one reagent of the metal-catalyzed chemical reaction and the dry formulation are brought together. For example, according to one or more embodiments, the use comprises a step of ultracentrifugation of the emulsion. Such an ultracentrifugation step can, for example, comprise one or more ultracentrifugation step at predetermined speeds, for example of between 1000 G and 50 000 G. According to one or more embodiments, the treatment step makes it possible to lower at least one among the mean diameter D of the droplets and the polydispersity index of the emulsion, and for example both this diameter and the polydispersity.

According to one or more embodiments, the emulsion formed by bringing together water or an aqueous solution with the dry formulation is a nanoemulsion, that is to say that the discontinuous phase comprises droplets of nanometric size, i.e. with a mean diameter D of less than 1 µm. According to one or more embodiments, the droplets of the emulsion exhibit a mean diameter D of between 100 nm and several microns, for example between 100 nm and 3000 nm.

In the present description and in the claims, unless otherwise indicated, mean diameter D of the droplets is understood to mean the mean diameter of the droplets. The mean diameter of the droplets can be measured with a particle size analyzer, based on the diffraction of light, for the droplets with a diameter D of greater than 1000 nm (volume-weighted De Brouckere mean diameter of the particles of the emulsion), and with a Dynamic Light Scattering (DLS) device for the droplets with a diameter D of less than 1000 nm. When the Dynamic Light Scattering (DLS) device is used to measure D, polydispersity index (or PI) of an emulsion is understood to mean the ratio of the square of the standard deviation to the square of the mean diameter of the droplets. When the particle size analyzer is used, polydispersity index (or PI) of an emulsion is understood to mean the D90/D10 ratio, where D10 diameter of the droplets is understood to mean the droplet diameter for which 90% of the total population of the droplets of the emulsion have a diameter greater than or equal to this value, and D90 diameter is understood to mean the droplet diameter for which 10% of the total population of droplets of the emulsion have a diameter greater than this value.

According to one or more embodiments, the catalyzed reaction in an aqueous medium is selected from the reactions which allow forming C—C, C—N, C—O or C—S bonds, such as, for example, cyanidation or sulfurization reactions, or cross-couplings, such as the Buchwald-Hartwig, Ullmann, Suzuki-Miyaura, Stille, Heck, Negishi or Sonogashira reactions.

According to one or more embodiments, at least one reagent of the catalyzed reaction in an aqueous medium comprises an unsaturated cyclic structure. According to one or more embodiments, the unsaturated cyclic structure comprises at least one nitrogen atom, for example two nitrogen atoms.

According to one or more embodiments of each aspect of the present patent application, the at least one metal catalyst comprises a metal selected from the transition metals, for example a late transition metal selected from Groups 8 to 11. According to one or more embodiments, the metal is selected from the group comprising iron, ruthenium, osmium, cobalt, rhodium, iridium, nickel, palladium, platinum, copper, silver and gold. For example, the metal is selected from the group comprising copper, iron and combinations thereof. According to one or more embodiments, the at least one metal catalyst comprises metal nanoparticles, for example copper, iron, copper oxide or iron oxide nanoparticles.

According to a third aspect, the present description relates to the use of a dry formulation obtained by drying an emulsion for carrying out a catalyzed reaction in an aqueous medium, wherein the dry formulation comprises at least one surfactant and at least one lipophilic compound, and wherein the use comprises the following steps:
bringing together water with the dry formulation, resulting in the formation of an emulsion comprising a discontinuous phase comprising droplets, the droplets including the at least one surfactant and the at least one lipophilic compound, and a continuous aqueous phase;
bringing together at least one metal catalyst with the dry formulation or with the emulsion formed by bringing together water with the dry formulation.

The operation of bringing together at least one metal catalyst can be carried out before or after bringing together water with the dry formulation or substantially at the same time as this.

Thus, the dry formulation suitable for the use according to the third aspect of the present description does not contain a metal catalyst. Nevertheless, the use of such a dry formulation for metal catalysis in an aqueous medium introduces the same advantages as the use of the dry formulation according to the first aspect described above with reference to the second aspect of the present description, namely, inter alia, the possibility of easily storing and transporting a set of reactors ready for use by simple addition of water, and giving, inter alia, results which are superior or comparable to conventional micellar catalysis. According to one or more embodiments, the metal catalyst brought together with the dry formulation or with the emulsion formed by bringing together water with the dry formulation is the same as the metal catalyst described in the first and second aspects of the present description.

Embodiments according to the aspects referenced above as well as additional advantages will become apparent from reading the following detailed description and the appended claims.

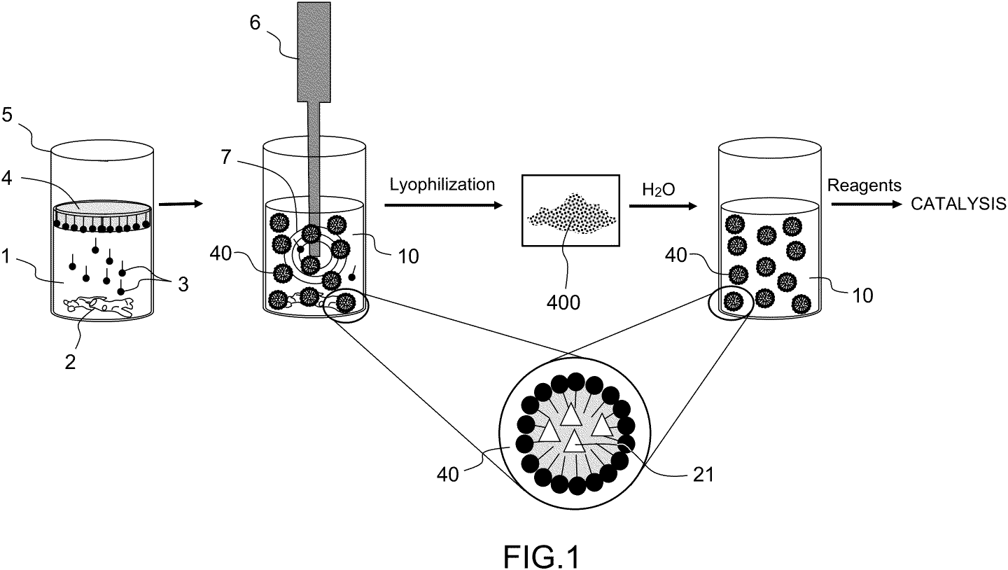

### BRIEF DESCRIPTION OF THE FIGURES

[FIG. 1] represents a diagram illustrating an embodiment of the dry formulation according to the first aspect of the present description, used to carry out a catalyzed reaction in an aqueous medium, and obtained in this embodiment by a process comprising the sonication of a mixture and the lyophilization of an emulsion.

### DETAILED DESCRIPTION

In the following detailed description of the embodiments of the present description, numerous specific details are set out in order to provide a more thorough understanding of the present description. However, it will be apparent to a person skilled in the art that the present description can be implemented without these specific details. In other cases, well-known features have not been described in detail to avoid needlessly complicating the description.

The present description provides non-limiting embodiments of dry formulations and of uses of dry formulations for carrying out catalyzed reactions in an aqueous medium.

### I. Examples of Use of a Dry Formulation for Carrying Out a Catalyzed Reaction in An Aqueous Medium

Examples 1-3 below relate to embodiments of the use of a dry formulation for carrying out a catalyzed reaction in an aqueous medium according to the third aspect of the present description. In examples 1-3, the dry formulation obtained by drying an emulsion comprises a surfactant and a lipophilic compound.

The use of the dry formulation includes the following steps:
bringing together water with the dry formulation, resulting in the formation of an emulsion comprising a discontinuous phase, comprising droplets including the at least one surfactant and the at least one lipophilic compound, and a continuous aqueous phase;
bringing together at least one metal catalyst with the dry formulation or with the emulsion formed by bringing together water with the dry formulation.

### I.a. Process for Obtaining the Dry Formulation of Examples 1-3

The process for obtaining the dry formulations used in examples 1-3 is described in detail below. The process comprises the provision of a mixture comprising water (4 ml), a surfactant dissolved in the water (H12TAC7, 100 mg) and a lipophilic compound (tributyl O-acetylcitrate, 0.2 ml). The mixture is subsequently subjected to the action of ultrasound by immersing therein an ultrasound probe (Bioblock Scientific, Vibracell 7504). The ultrasound probe (Ø= 13 mm) is placed in the centrifuge tube in an ice bath for 16.75 minutes (in pulsed mode, corresponding to 2 minutes of sonication in total). The duty cycle applied is 11.94% and the sonication intensity is 60% (450 W). After having withdrawn the ultrasound probe from the emulsion, the emulsion is centrifuged (5 min at 17 000 G, followed by 5 min at 26 000 G) in example 1 or is not centrifuged in examples 2 and 3. The emulsion or the supernatant resulting from the centrifugation are aliquoted in fractions of 500 µl. These aliquots are subsequently placed in the freezer for 12 h and then lyophilized for 24 h. The dry formulation is provided in the form of a powder obtained by lyophilization of a nanoemulsion. After addition of a volume of water equivalent to the volume of the starting aliquot (500 µl), the rehydrated emulsion contains a discontinuous phase composed of droplets with a mean diameter D equal to 239 ± 6 nm (PI = 0.249) for the case of example 1 (emulsion having undergone a centrifugation step before lyophilization) and with a mean diameter D equal to 741 ± 29 nm (PI = 0.236) and 790 ± 32 nm (PI = 0.223) for the case of examples 2 and 3 respectively (not having undergone centrifugation before lyophilization).

### I.b. Use of the Dry Formulation in Catalysis in Examples 1-3

The dry formulation (10 to 12 mg) indicated in part I.a. is subsequently rehydrated by addition of 0.5 ml of water, resulting in the formation of an emulsion.

Three catalyzed reactions in an aqueous medium are presented below. The first two are Buchwald-Hartwig cross-coupling reactions (examples 1 and 2) and the third is an Ullmann cross-coupling (example 3).

### Example 1

Bromotoluene 1 (61 µl, 1 eq) is added to the emulsion formed by the addition of water to the dry formulation. The base tBuONa (74.3 mg), the metal catalyst with palladium in solid form (Pd(Cinnamyl)Cl)₂ (2.8 mg) and the phosphorus ligand tBuXPhos (9.3 mg), then the amide 4—MeO—Ph—C(O)NH₂ (90.7 mg), are added to the emulsion. The medium is then brought to 50° C. and stirred (1200 rev/min) for 16 h. The yield of the reaction in coupling product 2 was established at 99% (119.4 mg) by HPLC (caffeine was used as external standard).

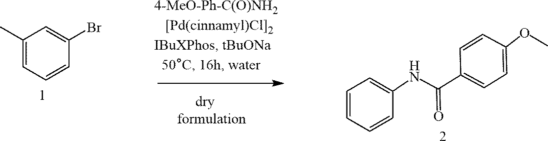

In comparison, the same reaction involving micelles of TPGS-750-M (10 mg/0.5 ml of water), a commercial surfactant described in the literature for micellar catalysis, gives a yield of 92%. Similarly, the micellar catalysis of the same reaction involving this time the surfactants H12TAC6 or H12TAC9 (under conventional micellar catalysis conditions, i.e. without lipophilic compound) gives in both cases a yield of 84%.

### Example 2

The reagents of the reaction, i.e. the pyridazine 3 (95 mg, 1 eq) and the amine Ph-(CH₂)₃-NH₂ (85 µl, 1.2 eq) are added to the emulsion formed by the addition of water to the dry formulation. A metal catalyst with palladium in solid form ((Pd(Cinnamyl)Cl)₂, 2.8 mg), a phosphorus ligand (tBuXPhos, 9.3 mg) and the base tBuONa (72.1 mg) are subsequently added to the emulsion. The medium is then brought to 50° C. and stirred (1200 rev/min) for 16 h. The yield of the reaction was established at 76% (110.6 mg) by HPLC (caffeine was used as external standard).

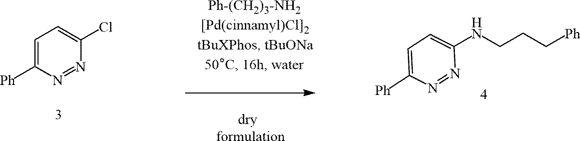

In comparison, the same reaction involving micelles of TPGS-750-M (10 mg/0.5 ml of water), a commercial surfactant described in the literature for micellar catalysis, gives a yield of only 15%, which reflects the marked improvement in catalysis conferred by the dry formulation. In addition, the replacement of the dry formulation by an equivalent amount of lipophilic compound (tributyl O-acetylcitrate, 10 mg/0.5 ml of water) results in the formation of the product 4 with a very low yield of 8%.

### Example 3

The pyrazinamide 5 (184 mg, 3 eq) and the iodotoluene 6 (64 µl, 1 eq) are added to the emulsion formed by the addition of water to the dry formulation. A metal catalyst with copper in solid form (CuBr₂, 11.2 mg), a diamine ligand L2 (7.1 mg), an additive (D-glucose, 9.0 mg) and a base tBuONa are added to the emulsion. The medium is then brought to 50° C. and stirred (1200 rev/min) for 20 h. Purification is carried out by column chromatography on silica gel with the following eluent: n-heptane/ethyl acetate (7/3 to 5/5). After evaporation, the coupling product is recovered in the form of a white solid (43 mg, 40%).

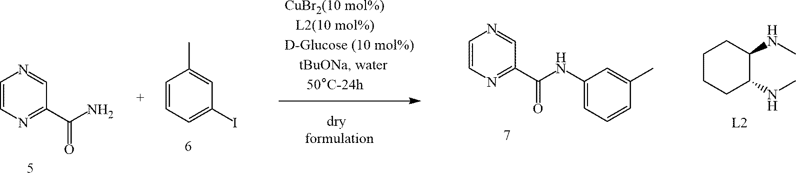

In comparison, the same reaction involving micelles of TPGS-750-M (10 mg/0.5 ml of water), a commercial surfactant described in the literature for micellar catalysis, gives a comparable yield of 41%.

### II. Illustration of a Process for the Formation of Dryformulations According to The Present Description and of Their Use in the Context of Catalysis in an Aqueous Medium

### II. A. Illustration of the Preparation of a Dry Formulation and of Its Use in Catalysis

FIG. 1 illustrates an embodiment of a dry formulation according to the first aspect of the present description, referenced 400 in the figure, obtained by drying an emulsion. The dry formulation 400 comprises a surfactant, a lipophilic compound and a metal catalyst. The dry formulation 400 is obtained by a process comprising the provision of a mixture contained in a container 5 and comprising water 1, a surfactant 3, a lipophilic compound 4 and a source 2, i.e., in this example, a piece of a metal-hyperaccumulating plant comprising a metal catalyst 21. The process additionally comprises emulsifying the mixture, carried out by sonication in this case, through an ultrasonic rod 6, capable of emitting ultrasonic waves 7. The sonication of the mixture results in the formation of an emulsion comprising a continuous aqueous phase 10 and a discontinuous phase comprising droplets 40 of core-shell type. As shown in FIG. 1, the droplets 40 consist of an oily core stabilized by a surfactant shell, exhibiting a certain content of metal catalyst 21. The metal catalyst 21 as represented in FIG. 1 is present exclusively at the core of the droplet. However, in other embodiments of the present description, the metal catalyst can be present solely at the shell of the droplet. In other embodiments, the metal catalyst can be found both at the core and the shell of the droplet.

The process for obtaining the dry formulation 400 further comprises a step of lyophilization of the emulsion, resulting in the formation of a dry formulation 400 which can be stored in the form of an easily transportable powder. The addition of water to this dry formulation, i.e. the rehydration, results in the formation of an emulsion exhibiting substantially the same features as before drying. However, in other embodiments of the use of the dry formulation than that illustrated by FIG. 1, the rehydration of the emulsion can result in an emulsion exhibiting different features from the emulsion before drying, e.g. in terms of mean diameter D and of polydispersity index.

### II. B. Exemplary Process for Obtaining a Dry Formulation Comprising a Metal

The source comprising the at least one metal catalyst is, in this example, material resulting from the recycling of electronic waste, and is provided in the form of a micellar solution. Such a source results from the extraction of an aqueous multimetal solution prepared by the applicants - supposed to represent material resulting from the recycling of electronic waste -, followed by the back extraction of the organic phase which has been used to extract the at least one metal catalyst and which comprises, besides the at least metal catalyst, at least one organic solvent and/or at least one hydrophobic complexing agent.

### 1. Extraction of Pd From a Multimetal Solution

24.9 mg of palladium nitrate dihydrate, 723.4 mg of iron nitrate nonahydrate and 732.6 mg of copper nitrate dihydrate are weighed out in a 100 ml flask. Everything is dissolved with a nitric acid solution (1 M - 2 M or 3 M). The solution is aliquoted and then quantitatively determined by ICP-AES (Inductively Coupled Plasma - Atomic Emission Spectroscopy/Spectrometer). The solution contains 2000 ppm of copper (Cu), 1000 ppm of iron (Fe) and 100 ppm of palladium (Pd).

The multimetal solution is brought into contact with an organic phase dimethyl-dibutyl-tetradecyl-1,3-malonamide (DMDBTDMA, 0.5 M/toluene) or bis(2-ethylhexyl) sulfoxide (BESO, 0.2 M/n-heptane) in a 15 ml plastic tube with a ratio of the volumes Vorganic/Vaqueous = 1/1. The mixture is stirred vigorously using an IKA-Vibrax VXR stirrer at 1200 revolutions.min⁻¹ for 1 h. The two resulting phases (aqueous phase 1 and organic phase 1) are then separated.

### 2. Back Extraction of Pd From a Multimetal Solution

The organic phase 1 is brought into contact with an aqueous solution containing the surfactant H12TAC5 (2 wt%) with a ratio of the volumes Vorganic/Vaqueous = 1/1. The mixture is stirred vigorously using an IKA-Vibrax VXR stirrer at 1200 revolutions.min⁻¹ for 1 h min. The mixture is subsequently centrifuged and the two resulting phases (aqueous micellar solution and organic phase 2) are separated.

### 3. Preparation of the Dry Formulation Containing Recycling Palladium

The aqueous micellar solution containing palladium (4 ml) is brought into contact with a solution of lipophilic compound, i.e. tributyl O-acetylcitrate (0.2 ml), then the mixture is subjected in an ice bath to the action of ultrasound using an ultrasound probe (Bioblock Scientific, Vibracell 7504) with a diameter of 13 mm for 16.75 min (in pulsed mode, corresponding to 2 minutes of sonication in total). The duty cycle applied is 11.94% and the sonication intensity is 60% (450 W). After having withdrawn the ultrasound probe from the emulsion, the emulsion can be directly aliquoted (500 µl) or else it can be centrifuged (5 min at 17 000 G, followed by 5 min at 26 000 G). The emulsion is quantitatively determined by ICP-AES before centrifugation. Its Pd concentration, thus measured, is approximately 8 mM. The emulsion or the supernatant resulting from the centrifugation are aliquoted in fractions of 500 µl. These aliquots are subsequently placed in the freezer for 12 h and then lyophilized for 24 h. The dry formulation is provided in the form of a powder obtained by lyophilization of a nanoemulsion. After addition of a volume of water equivalent to the volume of the starting aliquot (500 µl), the rehydrated emulsion contains a discontinuous phase composed of droplets with a mean diameter D equal to 660 nm (PI equal to 0.26).

### II.c. Use of the Dry Formulation in Catalysis in Example 4

The dry formulation indicated in part II.b. (resulting from the lyophilization of a 500 µl aliquot of emulsion) is subsequently rehydrated by addition of 0.5 ml of water, resulting in the formation of an emulsion.

Example 4 below describes an example of application of the dry formulation for carrying out a catalyzed reaction in an aqueous medium, namely a Suzuki-Miyaura cross-coupling.

### Example 4

The dry formulation containing the palladium is dissolved in 0.5 ml of water in a 4 ml vial. Then, 3-bromoanisole 8 (1 eq, 68.013 mg, 46.27 microliters, 0.36 mmol), triethylamine NEt₃ (4 eq, 147.19 mg, 202.18 microliters, 1.45 mmol), phenylboronic acid 9 (1.5 eq, 66.507 mg, 0.55 mmol) and tri(tert-butyl)phosphonium tetrafluoroborate (0.044 eq, 4.64 mg, 0.016 mmol) are successively added. The reaction mixture is stirred at 22° C. for 18 h. The reaction mixture is then extracted twice with 3 ml of diethyl ether. The organic phases are combined and then evaporated under vacuum. The crude reaction product thus obtained is then purified by chromatography on silica gel with the eluent pentane:dichloromethane in order to obtain the expected compound 10 with a yield of 30%.

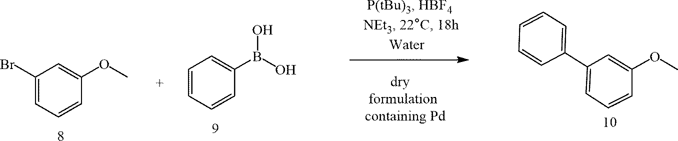

### III. Measurement of the Mean Diameter D of the Droplets and of the Polydispersity Index PI of the Emulsion

For each of the emulsions described above produced by addition of water to the dry formulations of examples 1-3, the mean diameter D of the droplets and the polydispersity index of the emulsion are measured by dynamic light scattering (DLS) using a Nanosizer Nano-S (Malvern Instrument). An aliquot of emulsion is diluted by 10 in milliQ® water, is placed in a 45 µl quartz cell and undergoes 6 measurements of 15 seconds each. The hydrodynamic diameter or mean diameter D was obtained by averaging the results of the 6 measurements. The measurements were taken at an angle of 173° using a laser, the wavelength of which is 633 nm. The data of the DLS are calculated on an intensity basis. The polydispersity index (or PI) corresponds to the ratio of the square of the standard deviation to the square of the mean diameter D of the droplets.

1. A dry formulation comprising at least one surfactant, at least one lipophilic compound and at least one metal catalyst, wherein the dry formulation has a water content of less than 10 wt%, with respect to the total weight of the dry formulation, and wherein:
the at least one surfactant is selected from the group comprising dendrimers of Dendri-TAC type, oligomers of FᵢTACₙ or HᵢTACₙ type, TPGS 1000, TPGS 750 M, surfactants derived from sugars and/or amino acids, and combinations thereof;
the at least one lipophilic compound is selected from the group comprising lipids, hydrophobic complexing agents and combinations thereof; and
the at least one metal catalyst comprises a metal selected from Groups 3 to 12 of the Periodic Table.

2. The dry formulation according to claim 1, wherein the lipid is selected from the group comprising glycerol mono-, di- or triesters, or glycerol derivatives, citric acid mono-, di-, tri- or tetraesters or citric acid derivatives, fatty acids, monoesters of fatty acids, sterides, sphingolipids, glycerophospholipids, polyketides, saccharolipids, lipids derived from prenol, essential oils, fat substitutes, waxes and combinations thereof.

3. The dry formulation according to claim 1, wherein the hydrophobic complexing agent is selected from the group comprising trialkyl phosphates and dialkyl sulfides.

4. The dry formulation according to claim 1 , wherein the at least one lipophilic compound is present in a percentage by weight, with respect to the total weight of the dry formulation, of at least 50 wt%.

5. The dry formulation according to claim 1 , wherein the at least one metal catalyst originates from a source selected from the group comprising a metal-accumulating plant, a metal-accumulating fungus or a metal-accumulating alga, material resulting from the recycling of electronic waste, polluted surface or ground water comprising a predetermined concentration of metals, an ore and combinations thereof.

6. The dry formulation according to claim 1 , wherein the at least one metal catalyst comprises a metal selected from the group consisting of copper, iron and combinations thereof.

7. A method for for carrying out a catalyzed reaction in an aqueous medium, the method comprising carrying out a catalyzed reaction in an aqueous medium with the dry formulation, wherein the dry formulation is as defined in claim 1.

8. The method according to claim 7, comprising bringing together water with the dry formulation, resulting in the formation of an emulsion comprising:
a discontinuous phase comprising droplets including the at least one surfactant, the at least one lipophilic compound and the at least one metal catalyst; and
a continuous aqueous phase.

9. The method according to claim 8, further comprising a step of ultracentrifugation of the emulsion.

10. The method according to claim 8, wherein the droplets exhibit a mean diameter D of between 100 nm and 3000 nm.

11. The method according to claim 8 , wherein the reaction allows forming a C—C bond, a C—N bond, a C—O bond or a C—S bond.

12. A method for for carrying out a catalyzed reaction in an aqueous medium with a dry formulation obtained by drying an emulsion, wherein the dry formulation comprises at least one surfactant and at least one lipophilic compound, wherein:
the at least one surfactant is selected from the group comprising dendrimers of Dendri-TAC type, oligomers of FᵢTACₙ or HᵢTACₙ type, TPGS 1000, TPGS 750 M, surfactants derived from sugars and/or amino acids, and combinations thereof;
the at least one lipophilic compound is selected from the group comprising lipids, hydrophobic complexing agents and combinations thereof;
the method comprising the following steps:
bringing together water with the dry formulation, resulting in the formation of an emulsion comprising:
a discontinuous phase comprising droplets including the at least one surfactant and the at least one lipophilic compound, and
a continuous aqueous phase;
bringing together at least one metal catalyst comprising a metal selected from Groups 3 to 12 of the Periodic Table with the dry formulation or with the emulsion formed by bringing together water with the dry formulation.

13. A process for obtaining a dry formulation according to claim 1, comprising the following steps:
providing a mixture comprising water, at least one surfactant, at least one lipophilic compound and a source comprising at least one metal catalyst;
emulsifying the mixture, resulting in the formation of an emulsion;
wherein the emulsion comprises:
a continuous aqueous phase; and
a discontinuous lipid phase comprising the at least one lipophilic compound, the at least one surfactant and the at least one metal catalyst extracted from the source during the emulsifying; and
drying the emulsion; wherein:
the at least one surfactant is selected from the group comprising dendrimers of Dendri-TAC type, oligomers of FᵢTACₙ or HᵢTACₙ type, TPGS 1000, TPGS 750 M, surfactants derived from sugars and/or amino acids, and combinations thereof;
the at least one lipophilic compound is selected from the group comprising lipids, hydrophobic complexing agents and combinations thereof; and
the at least one metal catalyst comprises a metal selected from Groups 3 to 12 of the Periodic Table.

14. The process according to claim 13, wherein drying the emulsion consists of freeze-drying the emulsion.

15. A method for carrying out a catalyzed reaction, the method comprising carrying out a catalyzed reaction in an aqueous medium with the dry formulation obtained by the process according to claim 13.
